(19) United States
(12) Patent Application Publication
(10) Pub. No.: US 2012/0156042 A1
(43) Pub. Date: Jun. 21, 2012

(54) FAN BLADE SYSTEM

(75) Inventor: Chang-De Li, Hsin Chuan (TW)

(73) Assignee: ASIA VITAL COMPONENTS CO., LTD., Hsin Chuan (TW)

(21) Appl. No.: 12/972,477

(22) Filed: Dec. 19, 2010

(51) Int. Cl. B64C 11/04

(52) U.S. Cl. 416/204 R

(57) ABSTRACT

A fan blade system includes a hub and a plurality of fan blades. The hub has a sidepiece and a plurality of protrusions alternately disposed along the sidepiece. Each of the fan blades corresponds to one of the protrusions and extends radially outwards from the sidepiece. Each protrusion is embedded in a corresponding fan blade and couples the fan blade to the hub. Both the hub and the plurality of protrusions are made of metallic material, while the plurality of fan blades is made of plastic material. The fan blade system provides consistent and mass-produceable fan blades with enhanced mechanical strength.

### BACKGROUND OF THE INVENTION

1. Field of the Invention

The present invention relates to a fan blade system, and especially to a mass-produceable fan blade system with enhanced mechanical strength and an improved product yield rate.

2. Brief Description of Related Art

The recent development in electronic industries has improved the performance of electronic components and sped up their operation process. As internal chipsets' operation speed improves and the number of chips included in them increases, the heat produced by chips in operation increases correspondingly. Any delay in heat dissipation, in consequence, would affect the function of an electronic component and reduce its operation speed; further, continuous accumulation of heat may even burn out the electronic component. Therefore, heat dissipation for electronic components has become a major concern for the electronic industries, and a conventional solution is the use of a cooling fan for heat dissipation.

Conventional cooling fans are either plastic or metallic. A conventional plastic fan includes a hub and a plurality of fan blades extending from the sidepiece of the hub. The hub and the plurality of fan blades are made of plastic material and produced by one-piece injection molding process. The size of fan blades' external diameter determines the air flow volume of a cooling fan. But since the mechanical strength of such fan blades is low, increase in their external diameter would easily cause fractures in the fan blades and likewise between the fan blades and the hub due to bumping or crushing.

A conventional metallic fan includes a hub and a plurality of fan blades, which are both made of metallic material, are first separately produced by stamp molding process, and are then welded together. In the process of welding, the fan blades have to be firmly fixed to the hub, the welding positions precise, and the amount of the applied welding flux appropriate. The complexity of such a method reduces the product yield rate and makes mass production impossible.

### BRIEF SUMMARY OF THE INVENTION

To solve the foregoing problems, it is an object of this present invention to provide a fan blade system with enhanced mechanical strength.

It is a further object of the present invention to provide a fan blade system with an improved product yield rate and consistent fan blades.

It is a further object of the present invention to provide a mass-produceable fan blade system.

With the above objects in mind, the present invention is a fan blade system including a hub and a plurality of fan blades. The hub has a sidepiece and a plurality of protrusions alternately disposed along the sidepiece. Each of the fan blades corresponds to one of the protrusions and extends radially outwards from the sidepiece. Each protrusion is embedded in a corresponding fan blade and couples the fan blade to the hub. Both the hub and the plurality of protrusions are made of metallic material, while the plurality of fan blades is made of plastic material.

### BRIEF DESCRIPTION OF THE DRAWINGS

FIG. 1 is a stereoscopic schematic drawing of a preferred embodiment according to the present invention;

FIG. 2 is a broken-out section view of a preferred embodiment according to the present invention;

FIG. 3 is a stereoscopic schematic drawing of another preferred embodiment according to the present invention; and

FIG. 4 is a broken-out section view of another preferred embodiment according to the present invention.

### DETAILED DESCRIPTION OF THE INVENTION

Reference will now be made in detail to the preferred embodiment of the present invention, two examples of which are illustrated in the accompanying drawings.

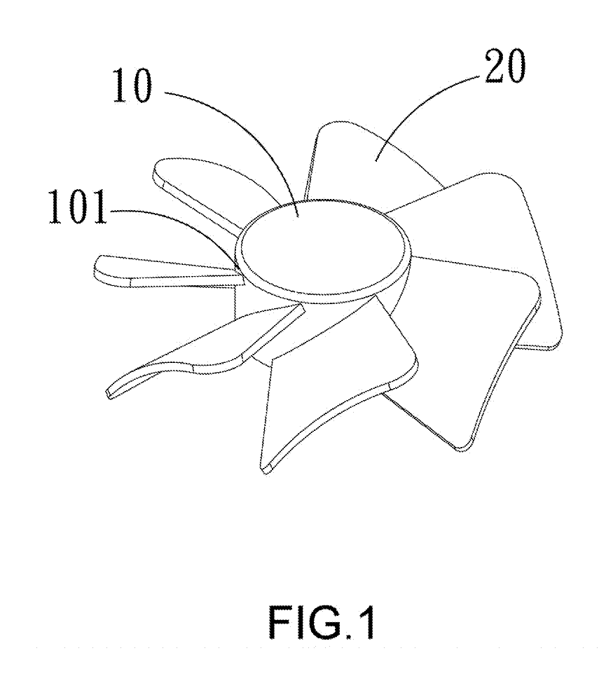

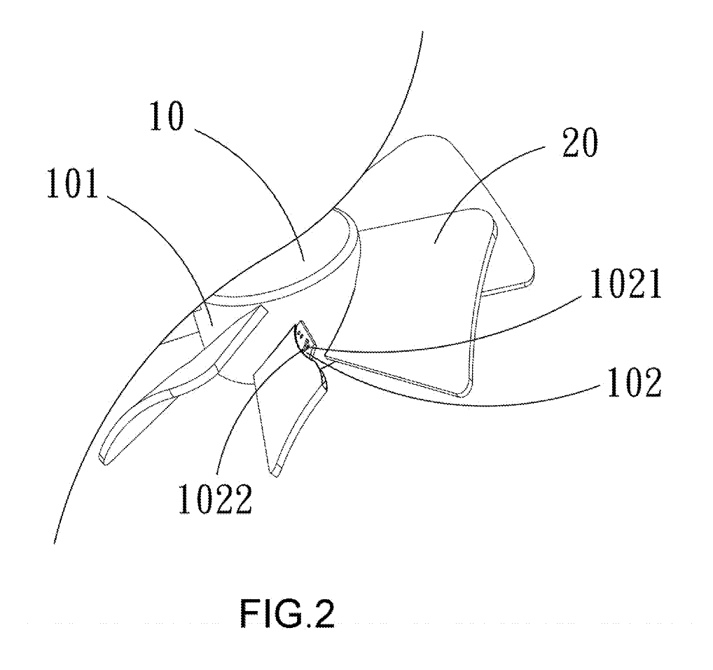

As shown in FIGS. 1 and 2, a preferred embodiment of fan blade system according to the present invention includes a hub 10 and a plurality of fan blades 20. The hub 10 includes a sidepiece 101 and a plurality of protrusions 102. The sidepiece 101 is formed along the side of the hub 10, and the protrusions 102 are alternately disposed along the sidepiece 101.

Each of the protrusions 102 has at least an opening 1021 and at least a nose 1022. Each of the fan blades 20 corresponds to one of the protrusions 102 and extends radially outwards from the sidepiece 101. Each protrusion 102 is embedded in a corresponding fan blade 20 and couples the fan blade 20 to the hub 10.

The hub 10 and the plurality of protrusions 102 are made of metallic material. The plurality of protrusions 102 is welded to the hub 10.

Further, the fan blades 20 corresponding to the protrusions 102 are made of plastic material and produced by one-piece injection molding process. The disposal of openings 1021 and noses 1022 couple the fan blades 20 tightly to the protrusions 102 and the hub 10.

In the aforementioned configuration, with the protrusions 102 made of metallic material being embedded in the fan blades 20, the mechanical strength of the fan blade 20 is enhanced. And since the fan blades 20 are made of plastic material, they are consistent and mass-produceable.

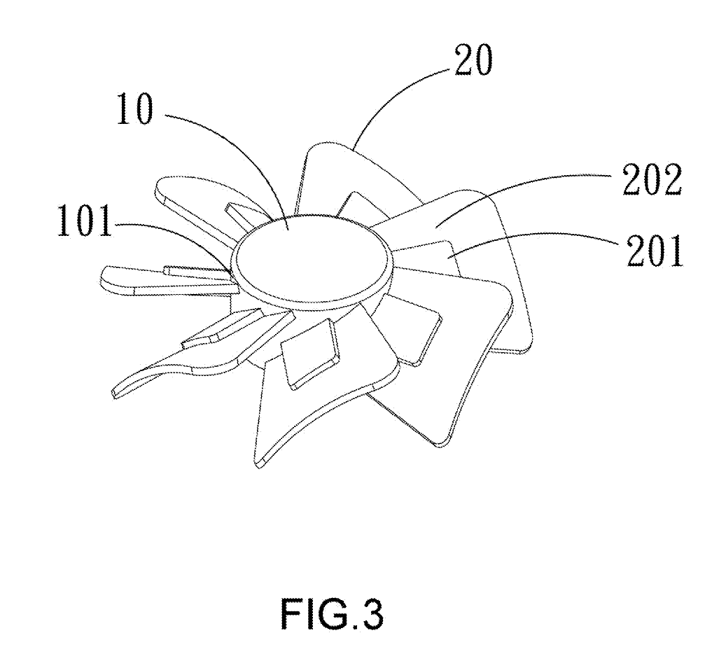

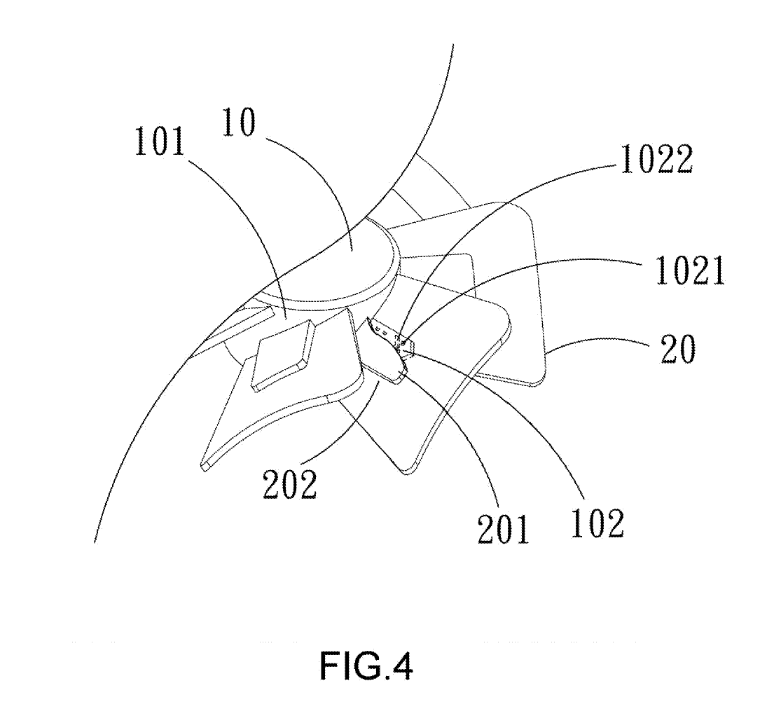

FIGS. 3 and 4 show another preferred embodiment of the present invention, wherein substantially similar components are connected in a similar manner and operate in a similar manner as in the aforementioned preferred embodiment except that each of its fan blades 20 has a covering portion 201 and a fan blade portion 202.

The covering portion 201 covers the protrusion 102 and is coupled to it. The fan blade portion 202 extends from the covering portion 201 along the external side of the covering portion 201, while the covering portion 201 is thicker than the fan blade portion 202. The covering portion 201 and the fan blade portion 202 are coupled to the hub 10.

The covering portion 201 and the fan blade portion 202 are made by one-piece injection molding process as in the first preferred embodiment, so that the fan blade 20 is of a whole form.

In view of the foregoing considerations, the present invention relates to a fan blade system which has the advantages of increasing the mechanical strength of fan blades, improving the product yield rate of fan blades, and mass-producing consistent fan blades.

As is understood by a person skilled in the art, the foregoing preferred embodiments of the present invention are illustrated of the present invention rather than limiting of the present invention. It is intended to cover various systems and similar arrangements included within the spirit and scope of the appended claims, the scope of which should be accorded the broadest interpretation so as to encompass all such systems and similar structures.

The invention claimed is:

1. A fan blade system comprising:
a hub having a sidepiece and a plurality of protrusions alternately disposed along the sidepiece; and
a plurality of fan blades, wherein each of the fan blades corresponds to one of the protrusions and extends radially outwards from the sidepiece, and wherein each protrusion is embedded in a corresponding fan blade and couples the fan blade to the hub.

2. A fan blade system as in claim 1, wherein the hub is made of a metallic material.

3. A fan blade system as in claim 1, wherein the protrusions are made of a metallic material.

4. A fan blade system as in claim 1, wherein the protrusions are welded to the hub.

5. A fan blade system as in claim 1, wherein the fan blades are made of a plastic material.

6. A fan blade system as in claim 5, wherein the fan blades cover the protrusions.

7. A fan blade system as in claim 1, wherein each fan blade has a covering portion and a fan blade portion, wherein the covering portion covers a corresponding protrusion, and wherein the fan blade portion extends from the covering portion along the external side of the covering portion.

8. A fan blade system as in claims 6, wherein each fan blade has a covering portion and a fan blade portion, wherein the covering portion covers a corresponding protrusion, and wherein the fan blade portion extends from the covering portion along the external side of the covering portion

9. A fan blade system as in claim 1, wherein each protrusion has at least an opening.

10. A fan blade system as in claim 4, wherein each protrusion has at least an opening.

11. A fan blade system as in claim 10, wherein each protrusion has at least a nose.

12. A fan blade system as in claim 9, wherein each protrusion has at least a nose.

13. A fan blade system as in claim 1, wherein each protrusion has at least a nose.

14. A fan blade system as in claim 4, wherein each protrusion has at least a nose.
